(19) United States
(12) Patent Application Publication
(10) Pub. No.: US 2026/0295864 A1
(43) Pub. Date: Oct. 1, 2026

(54) EFFECTOR WITH ADAPTIVE CONTOUR AND VARIABLE GRIPPING CAPABILITY

(71) Applicant: Silana GmbH, Wien (AT)

(72) Inventors: Michael MAYR, Wien (AT); Michael HOFMANNRICHTER, Baden (AT); Anton WOHLGEMUTH, Stainz (AT); Urs HUNZIKER, Meilen (CH)

(73) Assignee: Silana GmbH, Wien (AT)

(21) Appl. No.: 19/489,853

(22) PCT Filed: Jun. 6, 2024
(86) PCT No.: PCT/EP2024/065650

§ 371 Date: Dec. 3, 2025

(30) Foreign Application Priority Data
Jun. 7, 2023 (DE) 10 2023 114 946.6

(51) Int. Cl. B25J 15/00; B25J 9/16; B25J 15/06

(52) U.S. Cl. CPC B25J 15/0066; B25J 9/1679; B25J 15/0616

(57) ABSTRACT

The present disclosure relates to a system for handling and processing fabric parts. The system comprises a handling robot with an effector for handling a fabric part and a joining unit for at least one of processing a fabric part and connecting at least two fabric parts. The effector is configured to separate a fabric part from a fabric stack, to feed it to the joining unit and to hold it during processing by the joining unit, wherein the effector comprises at least five fixing elements. Each fixing element is configured to fix a region of the fabric part to the effector, wherein the five fixing elements are coupled to the effector so as to be movable relative to one another.

This application is a national US phase of PCT/EP2024/065650 which claims the benefit of the filing date of German Patent Application No. 10 2023 114 946.6 filed 7 Jun. 2023, the disclosure of which is hereby incorporated herein by reference.

### TECHNICAL FIELD

The disclosure relates to a system and a method for handling and processing fabric parts.

### BACKGROUND OF THE DISCLOSURE

In the technical field of textile processing, it is an aim to increase the degree of automation in order to reduce personnel costs and correspondingly production costs.

A textile processing system, which is configured, for example, for automated sewing, requires a handling mechanism in order to separate the fabric from a stack and to feed it to a sewing system (or sewing machine) in sufficient proximity after a manipulation. For this purpose, robots with an effector are used, on which corresponding gripping mechanisms for gripping a piece of textile are arranged. However, fabric parts, which represent a piece of clothing, have different sizes and can have different properties (thickness, air permeability, stiffness, etc.) both among one another and within the same piece.

In order to grip these thin and easily deformable pieces of textile, high demands are placed on the handling of the pieces of textile during the textile processing. For the manipulation of pieces of textile, different types of effectors with corresponding grippers are known in robotics. These grippers can be configured as contour-adaptive grippers and, for example, enable an adaptable gripping around of different types of pieces of textile. Furthermore, different vacuum gripping systems are known, which can fix and handle the piece of textile by means of suction cups.

However, the known handling systems usually have effectors with no more than four gripping arms, wherein each gripping arm comprises only one degree of freedom within an x-y-plane, in which the piece of textile is present. In other words, a gripping arm can only adapt itself to a contour of the piece of textile within the x-y-plane. The necessary adaptive grippers of the handling mechanism or of the effector, which are optimized precisely for this problem, are thus highly restricted to predetermined contours of the piece of textile. Therefore, hitherto, individual effectors or sewing frames have been used, which are adapted to the individual pieces of fabric (in terms of size and nature).

### SUMMARY OF THE DISCLOSURE

There may be a need to provide a handling system for fabric parts, which can adapt itself flexibly to different contours of fabric parts.

This need is met with a system and a method for handling and processing fabric parts according to the subject matters of the independent patent claims.

According to a first aspect of the present disclosure, a system for handling and processing fabric parts is described. The system comprises a handling robot with an effector for handling a fabric part and a joining unit (German: Fügeeinheit) for processing a fabric part and/or for connecting at least two fabric parts. The effector is configured to separate a fabric part from a fabric stack, to feed it to the joining unit and to hold it during processing by the joining unit.

The effector comprises at least five fixing elements. Each fixing element is configured to fix a region of the fabric part to the effector, wherein the five fixing elements are coupled to the effector so as to be movable relative to one another along an x-y plane in such a way that connecting lines between the fixing elements form an adjustable pentagon within the x-y plane, thereby allowing that a fixable fabric part can be spanned (German: aufspannbar). In the case of more than five fixing elements, a corresponding hexagon in the case of six fixing elements or a corresponding polygon with n edges in the case of n fixing elements can be formed accordingly.

Furthermore, according to a further aspect, a method for handling and processing fabric parts is described. According to the method, a fabric part is separated from a fabric stack by means of an effector of a handling robot for handling the fabric part and the fabric part is fed to a joining unit by means of the effector. The fabric part is processed in a joining unit and/or at least two fabric parts are connected by the joining unit. The effector is configured to hold the fabric part during processing by the joining unit, wherein the effector comprises at least five fixing elements and wherein each fixing element is configured to fix a region of the fabric part to the effector. The fixing elements are moved to one another along an x-y plane relative to one another, so that connecting lines between the fixing elements form an adjustable pentagon within the x-y plane, thereby allowing that the fixed fabric part can be spanned.

The handling robot comprises the effector to which the corresponding fixing elements are attached. The handling robot is attached to the ground by a stationary robot base in order to introduce corresponding forces into the ground. Alternatively, the handling robot is also configurable in such a way that the robot base is configured to be movable along the ground. A robot arm can be arranged between the effector and the robot base, which robot arm comprises, for example, one or more joints in order to thereby control the effector into a desired position.

The handling robot is a programmable multi-purpose handling device for moving material, workpieces, tools or special devices. In particular, the handling robot is configured to handle or manipulate the fabric parts and to move and position them accordingly. In other words, the handling robot enables a machine-controlled position change possibility in more than one axis and/or along a translational position change of the fabric parts.

Accordingly, at least five adjustable and controllable fixing elements are arranged on the effector. The effector thus forms an end part with, for example, grippers as fixing elements, which grip and manipulate a fabric part (for example, a flat, unprocessed fabric part or an entire piece of clothing as a fabric part).

The joining unit is configured to process the fabric part and/or to connect at least two fabric parts. The joining unit can be a sewing machine, a welding machine, a stitching machine, a crocheting machine, an automatic gluing machine or further automatic connecting machines for fabric parts.

The term fabric part denotes the possible textiles or textile parts of a piece of clothing. The term fabric part includes different forms of knitted fabric (German: Gewirk), in particular woven (German: Gewebe) and non-woven fabrics (German: Vliese). The left/left side of a fabric part denotes the inner side (i.e., the fabric underside, fabric inner side or the “not beautiful side” of a fabric part). In the case of a piece of clothing, the left side corresponds to the non-visible side of the fabric part. The “beautiful side” of a fabric or fabric part is used as the right/right side of a fabric part (e.g., the fabric upper side, visible side, fabric outer side). In the case of a piece of clothing, the right side corresponds to the visible side of the fabric or fabric part (e.g., the outer side of a T-shirt).

The joining unit can, for example, connect two fabric parts to one another, so that a seam (fabric seam or weld seam, etc.) is produced. The seam describes, for example, the connection of two fabric parts by means of a thread or yarn, wherein at least the one material substantially represents a fabric, a non-woven fabric or a woven fabric.

As explained, the effector according to the disclosure comprises at least five fixing elements. A fixing element comprises at least one fixing mechanism, for example a mechanical gripper, gripper with vacuum nozzles, needle unit with holding needles, a fixing system with electrostatic attraction, fixing rollers, in particular opposing fixing rollers and/or clamps.

Combined grippers, which comprise, for example, vacuum nozzles for fixing by means of negative pressure and at the same time by means of holding needles, can also be fastened to the effector according to the disclosure. The fixing elements can be configured in such a way that they are configured with zones or fixing devices which fix the desired fabric part with different negative pressures, different surface flows and/or different electrostatic gripping positions for adaptation to specific textile properties of the fabric part.

The fixing elements respectively comprise, for example, at least one carrier rod (or, as described below, a framework of coupling rods) which is fastened with one end to the effector in a movable manner. Corresponding fixing devices or fixing mechanisms are provided along the carrier rod or at a free end of the carrier rod, such as, for example, a gripper or a holding needle device which comprises holding needles for holding the piece of fabric. The carrier rod can in particular be fastened to the effector in a pivotable and/or translationally displaceable manner. Furthermore, the carrier rod can, for example, be telescopically retractable and extendable in order to change its length. In addition, the carrier rod itself can comprise at least one joint, so that the carrier rod itself comprises two partial regions which are pivotable with respect to one another. An exact setting and adjustment of the gripping device of a fixing element can thus be enabled. The adjustment of the effector contour of the effector can be enabled, for example, by integrated actuators (e.g. stepper motors with mechanical transmission to the fixing elements).

The fixing elements are arranged at the effector in such a way that at least one fixing element or all at least five guide elements comprise two degrees of freedom per arm in an x-y plane and in particular a further additional degree of freedom in the z-plane (for folding away inactive grippers).

The x-y plane is defined as that plane in which the fabric part is present when it is fixed by the fixing elements. In particular, the fabric part is spanned (German: aufgespannt) between the fixing elements. In this spanned state, the fabric part has a plane shape, and thus lies within the x-y-plane. The normal of the x-y-plane forms the z-direction. In other words, the x-y-plane forms the fabric plane and the thickness of the fabric is defined along the z-direction.

The effector contour or the pentagon is defined by the connecting lines between the individual five fixing elements or the fixing points of the fixing elements, at which a holding contact with a held fabric part is present within the x-y-plane. The connecting lines thus form a pentagonal contour (effector contour) within the fabric part. Inside the pentagon, the fabric part can be spanned and thus defines the x-y-plane. At the outer edge regions of the fabric part, which lie outside the pentagon defined by the fixing elements, the fabric part can be unspanned (German: ungespannt) and project so to speak from the x-y-plane. In a specific operating state, three fixing elements can be aligned along a straight line. The connecting lines between the respective outer fixing elements to the inner fixing element along this straight line also form two connecting lines, so that according to the definition according to the disclosure, a pentagon is still present.

With the handling system according to the disclosure, an improved handling during the separating of fabric parts from a stack and an improved fixing of fabric parts during the joining step is enabled. A separating means a receiving or pickup of one or two fabric parts from a (usually cut) stack of fabric parts. In the case of two layers of a fabric part lying one on top of the other, this can also be understood as lifting only one fabric part.

The solution according to the disclosure provides a handling robot with a contour-adaptive effector, which adapts to the contour of the piece of fabric. The effector comprises at least five fixing elements, which can span at least one pentagon in the x-y plane. Furthermore, a plurality of fixing elements can also span a hexagon, an octagon, a decagon or even an even larger polygon. As a result, it becomes possible to grip the prominent outer boundaries of a piece of fabric cut for a piece of clothing in the separating in such a flat manner that this can be placed in turn flat on a work surface subsequently for the further processing.

According to a further exemplary embodiment, the fixing elements are configured to grip a piece of fabric to be gripped after and/or during fixing to the fixing elements also within the contour of the piece of fabric and/or to re-span (German: Nachspannen) the piece of fabric by moving the fixing elements relative to one another.

Particularly in the case of larger pieces of fabric, there is the risk that these sag if they are lifted only at the relevant contour points or fixing points of the fixing elements. After pickup of the fabric part, the carrier rods or the grippers of the fixing elements can pretension the latter in the direction “away from the center”.

According to a further exemplary embodiment, the effector comprises at least one further fixing element, which is configured to support or fix the piece of fabric within the spanned contour and/or which is configurable to be folded away in the z-direction, which is oriented perpendicular to the x-y-plane. The further fixing element is also attached to the effector in a pivotable or translationally displaceable manner. The further fixing element also comprises a fixing mechanism at one end, wherein the fixing point of the fixing mechanism with the fabric part does not form the contour of the pentagon, but is present inside the pentagon. In other words, the further fixing element can push the center of the fabric part away from the effector or pull it toward the latter, in order to avoid sagging of the fabric part in the center of the pentagon.

For example, pretensioning can occasionally lead to a certain shrinkage (or slippage) after laying down for joining, if the fabric part contracts again due to its natural self-assembly effects. For this reason (precision during joining), the additional fixing element can avoid sagging in the center, without a high tension having to be introduced into the fabric part due to the outer fixing elements. For this reason, additional fixing elements can also be placed within the spanned contour, which retain the fabric part in the spanned plane, in particular also in the case of rapid position changes of the robot.

If the fabric part to be manipulated requires fewer end points than would be possible with the maximum number of fixing elements on the effector, the further fixing elements can either be used to reduce the sagging described above, or they can be folded away in the z-direction from the spanned x-y-contour plane.

According to a further exemplary embodiment, the effector comprises at least six, eight or ten fixing elements, which are coupled to the effector so as to be movable relative to one another and/or pivotable relative to one another along the x-y plane in such a way that at least one adjustable hexagon, octagon or decagon can be formed within the x-y plane by connecting lines between the fixing elements and in particular between the respective fixing points of the fixing elements with the fabric part, thereby allowing that the fixable fabric part can be spanned. Thus, for example, with an embodiment with six fixing elements, half of a tank top of the fabric part can be gripped at six points (2× shoulder, 2× under arm cut-out, 2× under collar) and spanned within the hexagon.

According to an exemplary embodiment, the effector comprises, for example, more than 10 fixing elements, in particular more than 15 fixing elements, preferably more than 20 fixing elements. The high number of fixing points thus achieved can be realized conventionally (simply many fixing elements with two degrees of freedom in the x-y plane). Alternatively, however, this can also be realized by adding an even higher number of fixing points with fewer degrees of freedom, if, for example, a dozen or a plurality of dozen star-shaped fixing points are realized with fixing elements and, for example, the carrier rod of the fixing elements are fixed in their angle relative to the effector or relative to one another, but are variable in their length. Thus, despite only one degree of freedom per fixing element, an effector contour with almost any shape can also be spanned by the high number of fixing points of the fixing elements. If the number of fixing points is disturbingly high for a small piece of fabric, the corresponding fixing elements can be folded away in the z-direction or an automatic folding away mechanism of, for example, every second fixing point can be realized mechanically by means of a forced guidance.

With a further exemplary embodiment, a contour, which is formed by the connecting lines of the fixing elements, is adjustable to be smaller than a part of an outer contour of the piece of fabric to be processed, at least during a part of the processing of the fabric part, in particular in the joining unit. So that the fabric part can be fed to a joining unit (for example sewing machine), it can comprise a protrusion at the edge relative to the contour (effector contour), which is formed by the connecting lines of the fixing elements.

According to a further exemplary embodiment, at least one of the fixing elements comprises a fixing mechanism selected from the group consisting of grippers, suckers, clamps, regions with increased friction and/or electrostatic attraction (electrostatic grippers), needles, rollers, freezing grippers, and/or Bernoulli grippers, wherein in particular at least one of the fixing elements can comprise a plurality of fixing mechanisms.

Electroadhesive grippers work with electrostatic fields. Holding forces are generated by polarization. They can be generated on the upper side of the fabric part, which is in contact with a gripper dielectric of the electroadhesive gripper.

A Bernoulli gripper comprises a suction body, wherein compressed air is flowed to the outside between the fabric part and the suction body along the x-y-plane via a flow channel of the suction body at the edge regions of the suction body. An air opening, which is coupled to the flow channel, is located in the center of the suction body. Due to the Bernoulli effect, air is sucked into the flow channel from the direction of the fabric part. A fixing force of the fabric part on the suction body is thus produced.

A freezer gripper comprises a highly cooled contact surface with the fabric part, as a result of which frozen water or ice as an adhesive adheres the fabric part to the contact surface. The water can be drawn as an adhesive from the atmosphere (air humidity) or can be added by an adhesive supply.

In other words, a plurality of (which or different) fixing devices or fixing mechanisms can be arranged, for example, on a carrier rod of a fixing element.

It can be helpful for the different mentioned tasks to be accomplished that differentiated fixing devices or fixing mechanisms are required at the fixing points or end points. Possible fixing mechanisms depending on the partial task, the fabric part properties and left/right side of the fabric part are, for example: grippers, suckers, clamps, regions with increased friction and/or electrostatic attraction, needles and/or rollers. Thus, for example, for the pushing of a fabric part on a table, a fixing device with a friction element with higher friction than the table is advantageous. For example, ‘no slip’ plastics can be suitable for this purpose. Alternatively, vacuum suckers as a fixing device are advantageous for lifting functions. In contrast, a plurality of fabric layers can ideally be fixed with microneedles (holding needles). For this reason, a plurality of different gripping systems can be indexed at a fixing point, so that both a pickup during the separating of the fabric parts from a stack and a feeding for joining or a precise stapling of fabric layers onto one another is possible with the same effector.

According to a further exemplary embodiment, at least one of the fixing elements is configured to fix the piece of fabric either from a right side of the piece of fabric or from a left side of the piece of fabric (i.e., from an inner side or from an outer side of the piece of fabric). Additionally or alternatively, at least one of the fixing elements is configured to fix the piece of fabric from a right side of the piece of fabric and from a left side of the piece of fabric. The fixing element is in particular configured to fix the left side or the right side with different fixing mechanisms, and/or the fixing element is in particular configured to fix the left side and the right side with a different fixing force. In other words, all fixing elements can fix one side of the fabric part. In addition or alternatively, fixing elements can be provided which, on the one hand, fix the right side and, on the other hand, fix the left side of the fabric part. Furthermore, fixing elements can be provided which comprise a fixing mechanism which grips around the fabric part at the edge and thus simultaneously fasten or grip the fabric part at the top and bottom or at the left and right side of the fabric part. Furthermore, a first type of fixing mechanisms (for example, vacuum suckers) can be provided on the one side of the fabric part, while a second type of fixing mechanisms (for example, grippers) can be provided on the other side of the fabric part. Different fixing mechanisms on the left side and on the right side of the fabric part have the advantage that one side of the fabric part can be gripped more gently, for example (e.g., on the left side with holding needles, but on the right side with vacuum, so that the right side remains more beautiful).

Furthermore, in a further exemplary embodiment, the fixing force of a fixing element can be controlled. The controllable fixing force can represent a further degree of freedom. Thus, for example, during a certain manipulation, a gripping force can be precisely so strong that the fixing element grips only precisely so much that, during the separating, only one fabric part is gripped by a stack. Thus, for example, a device can be configured as a fixing mechanism on a fixing element in such a way that holding needles can be introduced into a stack of fabric parts in such a way that a desired number of superimposed fabric parts can be fixed. Furthermore, by the fixing with different fixing forces of individual fixing elements, a different location-dependent gripping of a certain region of a fabric part can be enabled (e.g., fixed more firmly on the edge of the fabric part on which stitching is carried out, so that nothing slips).

Furthermore, alternatively or additionally, the fixing force can change temporally over the holding duration. For example, a high fixing force can be generated by a large amount of suction of a vacuum sucker during lifting, but only a small fixing force during displacement of the fabric part onto a worktable, because otherwise, for example, the effector sucks firmly on the worktable.

According to a further exemplary embodiment, the fixing force of one of the fixing elements is correspondingly adjustable depending on a fixing location within the contour of the fabric part, and/or the fixing mechanism of one of the fixing elements is adjustable depending on a fixing location of the fabric part.

According to a further exemplary embodiment, the fixing force and/or the fixing mechanism of one of the fixing elements is correspondingly adjustable depending on a temporal processing state of the fabric part.

According to a further exemplary embodiment, at least one of the fixing elements comprises an actuator, which is configured to control the fixing of the fabric part and/or to control the displacement of the fixing element within the x-y-plane.

Additionally or alternatively, the effector and/or the handling robot comprises an actuator, which is configured to transmit a fixing force to the fixing element for fixing the fabric part and/or to control a displacement force to the fixing element for displacing the fixing element within the x-y-plane.

According to a further exemplary embodiment, the handling robot comprises a robot base, on which the effector is movably arranged. The actuator is in particular installed in the robot base and is coupled to at least one of the fixing elements by means of an adjusting mechanism such that an actuator force can be transmitted to the effector by means of the adjusting mechanism in order to control the same, so that the actuator is independent of a movement of the effector.

The actuator generates, on the one hand, the drive force for one or more fixing elements and additionally comprises a transmission mechanism or an adjusting mechanism for transmitting the drive force to the fixing elements. For example, the actuator can be attached to the effector and move with the effector. For example, an actuator can generate or transmit a drive force for a plurality of or even all fixing elements or an actuator is correspondingly assigned to one fixing element. The actuator can represent, for example, an electric motor or a servo element, which generates a drive force for the fixing elements based on electrical energy. Furthermore, the actuator can represent a hydraulic or pneumatic force generator. The adjusting mechanism can transmit the drive force mechanically, for example via cable pulls, hydraulically or pneumatically to the fixing elements. Accordingly, the actuator and/or the actuators can be arranged in the robot base, so that the drive force can be transmitted to the fixing elements via the adjusting mechanism.

Thus, for example, the motors or actuators of the fixing point adjustment of the guide elements at the actuator can be omitted. By this removal of actuator (electro) mechanism, the weight of the effector can be reduced and thus either the energy consumption of the handling robot (with the same position change speed) can be reduced or (with a given robot power) the position change speed can be increased. For fixing an end position of the effector or a fixing element, a friction brake can be provided. Instead of a friction brake, a spring and latching mechanism on the effector side can also prevent a subsequent readjustment of the end positions.

According to a further exemplary embodiment, at least one of the fixing elements can be fixed in one position with a position holding force, wherein the position holding force is less than ⅕, in particular less than 1/10, preferably less than 1/20 of the power, which can be used for displacing the corresponding fixing element. The energy consumption of the setting of the fixing elements can thus be reduced. Since the adjustment of the fixing points is characterized by longer times with a constant setting, the construction of this setting mechanism is configured in such a way that, above all, energy is required for adjusting the fixing points of the fixing elements and not for holding the position (such as, for example, with stepper motors). An electric (electromagnetic brake) or a mechanical (friction brake, worm gear, etc.) brake can hold the fixing elements in position. In this embodiment variant, it has surprisingly been turned out that the stability of the effector (and thus the quality of the joining seam achieved) is significantly improved. The use of the holding energy can be optimized with respect to the energy required during the adjustment. Very good results were achieved if the holding power or position holding force is less than ⅕, in particular less than 1/10, especially preferably less than 1/20 of the power, is the energy (rated connection power of the actuator (adjusting motor)), which is necessary for moving the fixing elements.

According to a further exemplary embodiment, the fixing elements are configured such that the piece of fabric is fixed to the joining unit or to the joining units during the entire joining. One of the manipulations by the robot, which is now possible by the configuration of the effector according to the disclosure, is the feeding and/or the guiding of one or more fabric parts or layers during the joining. Due to the mentioned protrusion of the fabric part relative to the effector contour of the effector (for example of 2 cm), it is possible, on the one hand, to ensure sufficient proximity of the guide and thus freedom from folds, but, on the other hand, sufficient distance so that the effector does not collide with the joining unit. The mentioned variable gripping can also be relevant during the guiding and/or during the feeding to the joining. Thus, a stapling can be intensified in the region of the joining or certain holding points/fixing points can be at least partially released after the joining.

According to a further exemplary embodiment, the joining unit is selected from the group consisting of sewing machines, welding machines for welding fabric parts, stitching machines for stitching fabric parts, crocheting machines, automatic gluing machines for gluing fabric parts, in particular automatic hot gluing machines, and automatic ironing machines for ironing a fabric part.

According to a further exemplary embodiment, the handling robot comprises at least one sensor unit, wherein the sensor unit comprises an optical sensor for determining an orientation of the fabric part relative to the effector and/or the joining unit, a force sensor for measuring the fixing force of the fixing element for fixing the fabric part and/or a weight sensor for measuring a weight of the fixed fabric part. The handling robot is configured to control the fixing elements based on the measured sensor parameter of the sensor unit. Alternatively or additionally, the weight of the fabric stack (or the weight reduction) can also be measured during the separation with a sensor and can act back on the handling robot.

The effector and the fixing elements can thus be adapted in real time based on an external sensor signal. For example, an electronic weighing device of the fabric stack or of the load weight on the effector can determine whether actually only one fabric part or one fabric layer has actually been separated. Alternatively, a camera of the sensor can monitor the progress of the manipulation in different working steps and at the most act on the fixing mechanism or gripping mechanism or the manipulation of the effector. In particular, mechanisms of artificial intelligence can be used for this purpose, for example for the detection of folds or for preventing the formation of folds. In addition, a learning process can improve the recognition and/or the retroaction to the cleaning (German: Läuterung) of the handling robot or the gripping of the fabric part by means of the fixing elements.

According to a further exemplary embodiment, the fixing elements are movable relative to one another in an x-y plane in such a way that end positions of the fixing elements are adjustable with two degrees of freedom in the x-y plane. Furthermore, for example, the fixing elements are in particular further movable in the z-direction, so that end positions or fixing points of the fixing elements are adjustable with three degrees of freedom in the x-y plane and in the z-direction.

Thus, for example, a contour-defining end position of the effector can be controlled by two degrees of freedom: an actuator (e.g. stepper motor with reduction gear) for the central angle and an actuator for the length (e.g. stepper motor and transmission to threaded rod) of a rigid construction, at the end position of which the gripping mechanism of the fixing elements is seated. This corresponds to alpha and I in a two-dimensional central coordinate system (x-y-plane), which coincides with the fabric plane of the fabric part. This has the advantage that all relevant fixing points in the x-y-plane can be approached.

According to a further exemplary embodiment, the fixing mechanism comprises holding needles, which are configured in such a way that a penetration depth and/or a penetration angle of at least one holding needle is controllable, in particular in real time and/or based on a sensor feedback. An additional form of differentiated gripping can relate to the depth of a holding needle and/or the angle of a holding needle (and in particular a plurality thereof). Thus, for example, a holding needle can be inserted into the fabric part at a shallow angle or not so deep during the separating, whereas a steeper angle or a larger penetration depth can be used during the stitching of two fabric parts (for the joining) in order to securely grip both fabric parts.

According to a further exemplary embodiment, at least between two fixing elements a carrier element is attached, which carries the fabric part between the fixing elements. The carrier element is formed elastically in such a way that upon changing the distance of the two fixing elements a length and a shape of the carrier element is adaptable. The carrier element is configured in particular to hold the fabric part by means of vacuum and/or by means of holding needles. Furthermore, the fixing mechanisms, which are used in connection with the fixing elements, can also be formed around the carrier element.

The carrier element serves for stabilizing the fabric part between two adjacent fixing elements. The carrier element is arranged between two fixing elements and attached to them. The fabric part rests on the carrier element for stabilization or can be held actively by the carrier element. Sagging of the fabric part between two fixing elements is thus prevented, for example. The carrier element can be adjusted in its length. For example, the carrier element can be telescopically retractable and extendable. Furthermore, the carrier element can be formed elastically deformable. The carrier element can thus follow a different distance between two fixing elements.

For example, the carrier element can be arranged between two fixing points of two fixing elements and form an elastic and expandable square tube (e.g. made of silicone). The carrier element can be equipped with holes towards the fabric side. By compressing the carrier element the fabric part can be spanned in the holes. Alternatively, air can be sucked through the holes in order to generate a holding force. An auxiliary holding system between the end points of the fixing elements is thus realized by means of the carrier element. By a uniform elasticity distribution over the length of the carrier element a self-organizing effect of the carrier element can also be generated. The ends of the square tube can either be fastened to the fixing points of the fixing elements in a freely movable manner (so that the carrier element forms a straight line which always remains within the contour) or the initial angles of the carrier element can be set with a further actuator (or a fixing mechanism), as a result of which an improved contour adaptation is enabled. Alternatively to a vacuum system of the carrier element, microneedles (actively movable or passively stationary) or friction surfaces on the carrier element can be used for this purpose.

According to a further exemplary embodiment, the holding needles of the fixing mechanism or the holding needles of the carrier element have a diameter of less than 1300 micrometers, less than 900 micrometers, in particular less than 550 micrometers, further in particular less than 250 micrometers. It has been found that, in the case of fine microneedles as holding needles in combination with a suitable vacuum negative pressure and a suitable air stream, no quality-disturbing effects remain on the fabric surface after processing. This has been shown especially in the case of needle diameters of less than 1300 micrometers, less than 900 micrometers, in particular less than 550 micrometers, preferably less than 250 micrometers.

According to a further exemplary embodiment, the effector comprises an effector base and a central rod, wherein the effector base is attached to an arm element of the handling robot and the central rod extends from the effector base (in particular in the direction of the fabric part opposite the arm element). The fixing elements are attached to the central rod, wherein at least one fixing element comprises a coupling rod mechanism with a plurality of coupling rods connected in an articulated manner at articulation points.

At least two articulation points form fixing points, at each of which at least one fixing mechanism, for example, a suction device for fixing the fabric part, is provided. The coupling rods are coupled to one another in an articulated manner in the manner of a pantograph in such a way that the fixing points are displaceable relative to the central rod within the x-y plane and maintain a predefined change in distance proportional to the distance from the central rod during the displacement.

If, for example, one fixing point is now moved relative to the central rod by means of an actuator, the coupling rods coupled in the manner of a pantograph have the effect that the further fixing point is changed in a predetermined manner proportional to the distance from the central rod. The coupling rods form a framework which is designed in the manner of a pantograph in such a way that a predetermined proportionality of the fixing points is given during a displacement. If, for example, the outermost fixing point is displaced 5 cm further away from the central rod, the middle fixing point between the outer fixing point and the central rod can also move 5 cm due to the predetermined proportionality. The proportionality ratio would thus be 1 to 1. Alternatively, the coupling rods can be configured and coupled in such a way that any proportionality ratio is set with respect to the displacement distance. Thus, in a further exemplary embodiment, the coupling rods can be coupled in such a way that the outermost fixing point is displaced 10 cm further away from the central rod, and the middle fixing point between the outer fixing point and the central rod moves 5 cm due to the predetermined proportionality of 1:2 between the outer fixing point and the central rod. By means of the described arrangement of coupling rods in the manner of a pantograph, a plurality of fixing points can thus be drawn along the x-y plane, wherein a drive force only has to be transmitted to one fixing point, so that only one actuator is necessary.

According to a further exemplary embodiment, the fixing elements are attached pivotably to the central rod. An additional degree of freedom for the adjustment of the fixing elements can thus be enabled for the above-described arrangement of the coupling rod in the manner of a pantograph. In particular, for example, adjacent fixing elements can be pivoted relative to one another, so that their distance (in particular in the x-y plane) is adjustable.

According to a further exemplary embodiment, the effector comprises a sliding element, which is arranged on the central rod so as to be displaceable along the latter. The coupling rod mechanism is configured in such a way that a first coupling rod is fixedly attached to the central rod and a further second coupling rod, which is coupled in an articulated manner to the first coupling rod, is attached to the sliding element in such a way that, when the sliding element is displaced along the central rod, an angle between the first coupling rod and the second coupling rod and correspondingly the fixing points undergo a predefined change in distance proportional to the distance from the central rod.

The central rod forms so to speak a guide rod, which extends from the effector in the direction of the fabric parts. The sliding element can be guided in a sliding manner along the central rod. One end of the first coupling rod is fixedly attached to the central rod and one end of the second coupling rod is fixedly attached to the sliding element. If the sliding element now moves in the direction of the coupling point at which the first coupling rod is fixedly attached to the central rod, the ends of the first coupling rod and the second coupling rod approach one another. Correspondingly, the angle between the first coupling rod and the second coupling rod becomes smaller and the free ends of the first and second coupling rods correspondingly move away from the central rod. A distance of the free ends of the first and second coupling rods from the central rod can thus be set due to the displacement of the sliding element along the central rod. If a fixing point, to which a gripping element is attached, is located at a free end of the first or second coupling rod, the arrangement of the fixing point can correspondingly be set in particular along the x-y-plane. With the described exemplary embodiment, a mechanically robust solution can be provided, which enables a simple and robust control, in that, for example, an actuator only has to control the sliding element in order to set a corresponding distance or an alignment of a fixing element.

In an exemplary embodiment, one or more further fixing elements with corresponding coupling rods can be arranged on the sliding element. A plurality of fixing elements can thus be set or controlled when one and the same sliding element is controlled.

According to a further exemplary embodiment, the system comprises a control unit for controlling the handling robot and/or the joining unit, wherein the control unit is configured to collect and evaluate the data relating to the movement of the effector and data relating to the joining result of the joining unit in order to take measures relating to the control of the movement of the effector and of the joining sequence of the joining unit in the event of a predetermined deviation from a predefinable limit value. The control unit can be coupled to the individual sensors of the system in a wireless or wired manner in order to obtain the corresponding movement data, position data and state data of the effector as well as the data of the joining unit as well as the state data of the joint or of the joining result of the fabric part. Furthermore, the control unit can be equipped with a storage unit with a database or can be coupled to a remote, web-based database or database stored in a cloud. For example, desired values for the data or measured parameters can be present in the database. Based on an actual/desired value comparison, the control unit can generate corresponding control commands for the system. In other words, the system according to the disclosure uses the knowledge from the sensory evaluation as to whether the respective manipulation was successful. A change in the reliability can thus be detected and communicated to a superordinate system. A preventive maintenance or an adaptation of the handling parameters can thus be initiated, for example.

The control unit can be configured accordingly to adapt the gripping mechanisms in real time based on a sensor signal. For example, an electronic weighing device as a weight sensor of the fabric stack or a sensor for measuring the load weight on the effector can determine whether actually only one fabric layer has actually been separated. Alternatively, a camera as an optical sensor can monitor the progress of the manipulation in different working steps and at the most act back on the gripping mechanism or the manipulation. In particular, mechanisms of artificial intelligence can be used for this purpose. For example, it can be determined by means of optical sensors based on a contrast value analysis, for example, whether an impermissible formation of folds is generated due to a gripping of a piece of fabric. In addition, a learning process can improve the recognition and/or the retroaction to the handling robot and the gripping of this embodiment.

According to a further exemplary embodiment, in the case of a fixing mechanism by means of suction devices for fixing the fabric part, the negative pressure in the fixing mechanism can be varied by more than 15%, in particular more than 30%, preferably by more than 45%.

In the exemplary embodiment, in which the fixing mechanism is implemented by means of a suction device, a gripping function is achieved by means of negative pressure. The suction device comprises a suction cup or a suction bell, to which a vacuum pump or a suction pump is connected in order to suck air out of the suction cup. A negative pressure is generated in the volume between the fabric part and the suction cup, with which negative pressure a fixing force is generated. The negative pressure can be measured, for example, by means of sensors in order to control the suction power correspondingly by means of the control device.

The suction power or the negative pressure can be set for different fabric types of the fabric parts. Good results were achieved with the following negative pressure powers:

| | Suction Power in | Suction Power in |
|---|---|---|
| Type of fabric | [Pa] | [mbar] |
| Cotton 100% | 16020-18300 | 160.20-183.00 |
| Interlock Jersey | | |
| Cotton-Tencel (66/33) | 17060-19240 | 170.60-192.40 |
| Interlock | | |
| Cotton-Elastane | 18720-22300 | 187.20-223.00 |
| (95/5) Single Jersey | | |
| Denim | 13400-15600 | 134.00-156.00 |
| 100% Polyester - | 25370-27800 | 253.70-278.00 |
| Plain weave | | |

The control unit and the vacuum pump can be configured in such a way that a negative pressure can vary by more than 15%, in particular more than 30%, preferably by more than 45%. A high adaptability to different fabrics is thus enabled.

According to a further exemplary embodiment of the method, two fabric parts are at least partially superimposed and fixed at the joining unit by means of the effector, in particular with the fixing elements of the effector, wherein in particular the joining unit connects the two superimposed fabric parts, for example by means of sewing or welding.

With the system according to the disclosure for handling and processing fabric parts, not only is an effector considered in isolation, but also the interaction between effector and handling robot and between effector and joining unit. For example, it can be detected by means of the sensor system, for example, that only one piece of fabric is received during the separating. In addition, the joining unit and, for example, the forward conveyance of the fabric parts during the joining process can also be controlled in particular by means of the control unit. For example, depending on the fabric material, either a certain tension can be built up or reduced in the fabric part by means of the effector or its fixing elements during the joining process, or the fabric part can be moved faster or slower than the normal joining advance, if, for example, the woven fabric is opened up in the z-direction by the sewing technique.

With the effector according to the disclosure and in particular its fixing elements, different types of fabric parts can be separated and subsequently further processed with one and the same effector/robot.

With the adaptation according to the disclosure of the fixing elements along the x-y-plane, fabric parts can have precisely as much protrusion (which is outside the contour of the effector) over the fixing points that a feeding for joining and at the most later guiding during the joining is reliably possible. Since clothes are sewn on “left” in the plurality of cases, the system has to place the partial task “right” on “right” flush with the edge. This means that the technical and haptic differences of a fabric between the “beautiful side” and the “back side” have to be handled with the same infrastructure. In particular, the “beautiful side” may not be affected by the handling either optically or haptically. The fixing elements can grip a fabric part in such a gentle and balanced manner that no ironing of the piece of clothing is necessary after joining (energy and effort reduction).

It is pointed out that the embodiments described here represent only a limited selection of possible embodiment variants of the disclosure. It is thus possible to combine the features of individual embodiments with one another in a suitable manner, so that, for the person skilled in the art with the embodiment variants explicit here, a plurality of different embodiments are to be regarded as obviously disclosed. In particular, some embodiments of the disclosure are described with device claims and other embodiments of the disclosure are described with method claims. However, the person skilled in the art will immediately become clear when reading this application that, unless explicitly stated otherwise, in addition to a combination of features which belong to one type of subject matter of the disclosure, any combination of features which belong to different types of subject matter of the disclosure is also possible.

### BRIEF DESCRIPTION OF THE DRAWINGS

In the following, exemplary embodiments are described in more detail with reference to the attached drawings for further explanation and for a better understanding of the present disclosure. In the drawings:

FIG. 1 shows a schematic illustration of a system for handling and processing fabric parts according to an exemplary embodiment of the present disclosure.

FIG. 2 shows a schematic illustration of the effector with fixing elements according to an exemplary embodiment of the present disclosure.

FIG. 3 shows a schematic illustration of a fixing element with a gripper according to an exemplary embodiment of the present disclosure.

FIG. 4 shows a schematic illustration of a fixing element with a suction device according to an exemplary embodiment of the present disclosure.

FIG. 5 shows a schematic illustration of a fixing element with an electrostatically charged element according to an exemplary embodiment of the present disclosure.

FIG. 6 shows a schematic illustration of a fixing element with holding needles according to an exemplary embodiment of the present disclosure.

FIG. 7 shows a schematic illustration of a fixing element with a plurality of different holding mechanisms, for example with a suction device and holding needles according to an exemplary embodiment of the present disclosure.

FIG. 8 shows a schematic illustration of a fixing element with a gripper, which grips an upper side of a fabric part, according to an exemplary embodiment of the present disclosure.

FIG. 9 shows a schematic illustration of an effector with fixing elements, which are formed in the manner of a pantograph with coupling rods, according to an exemplary embodiment of the present disclosure.

FIG. 10 shows a schematic illustration of an effector, on which pivotable fixing elements are arranged, according to an exemplary embodiment of the present disclosure.

### DETAILED DESCRIPTION OF EXEMPLARY EMBODIMENTS

Identical or similar components in different figures are provided with identical reference numerals. The illustrations in the figures are schematic.

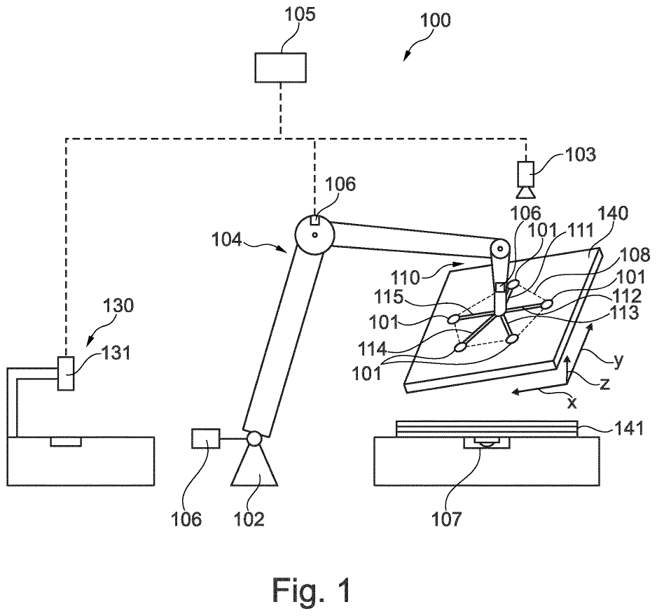

FIG. 1 shows a system for handling and processing fabric parts 140. The system comprises a handling robot 100 with an effector 110 for handling a fabric part 140 and a joining unit 130 for processing a fabric part 140 and/or for connecting at least two fabric parts 140. The effector 110 is configured to separate a fabric part 140 from a fabric stack, to feed it to the joining unit 130 and to hold it during processing by the joining unit 130, wherein the effector 110 comprises at least five fixing elements 111 to 115. Each fixing element 111 to 115 is configured to fix a region of the fabric part 140 to the effector 110, wherein the five fixing elements 111 to 115 are coupled to the effector 110 so as to be movable relative to one another along an x-y plane in such a way that connecting lines between the fixing elements 111 to 115 form an adjustable pentagon 108 within the x-y plane, thereby allowing that a fixable fabric part 140 can be spanned.

The handling robot 100 is attached to the ground by a stationary robot base 102 in order to introduce corresponding forces into the ground. The robot base 102 can be configured to be movable along the ground, for example. A robot arm 104 is arranged between the effector 110 and the robot base 102, which robot arm comprises, for example, one or more joints in order to thereby control the effector 110 into a desired position. The handling robot is configured to move and position the fabric parts 140. The handling robot 100 enables a machine-controlled position change possibility in more than one axis and/or along a translational position change of the fabric parts 140.

Accordingly, at least five adjustable and controllable fixing elements 111 to 115 are arranged on the effector 110. The effector 110 thus forms an end part with, for example, grippers as fixing elements 111 to 115, which grip and then manipulate a fabric part (for example, a flat, unprocessed fabric part or an entire piece of clothing as a fabric part) 140.

The joining unit 130 is configured to process the fabric part 140 and/or to connect at least two fabric parts 140. The joining unit 130 can be a sewing machine, a welding machine, a stitching machine, a crocheting machine, an automatic gluing machine or further automatic connecting machines for fabric parts. The joining unit 130 can, for example, connect two fabric parts 140 to one another, so that a seam (fabric seam or weld seam, etc.) is produced.

A fixing element 111 to 115 comprises at least one fixing mechanism. In the exemplary embodiment from FIG. 1, corresponding suction devices 101, which hold a fabric part 140, for example, by means of negative pressure, are arranged at the ends of the fixing elements 111 to 115.

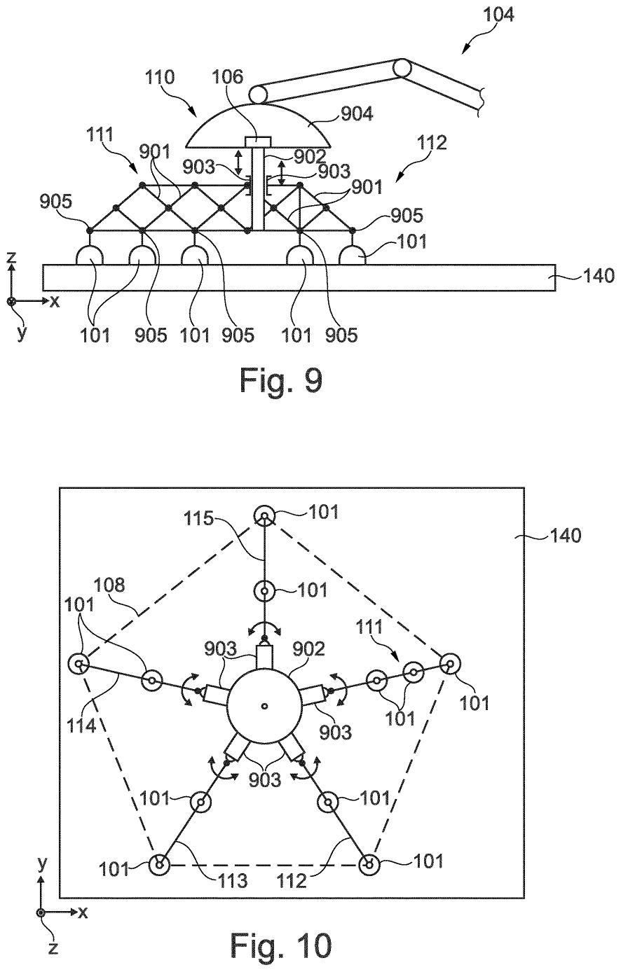

The fixing elements 111 to 115 respectively comprise, for example, at least one carrier rod (or, as described in FIG. 9, a framework of coupling rods 901) which are fastened with one end to the effector 110 in a movable manner. Corresponding fixing devices, such as, for example, a gripper 101 or a holding needle device (see FIG. 6), which comprises holding needles 601 for holding the fabric part 140, are provided along the carrier rod or at a free end of the carrier rod. The carrier rod can in particular be fastened to the effector 110 in a pivotable and/or translationally displaceable manner. Furthermore, the carrier rod can, for example, be telescopically retractable and extendable in order to change its length. In addition, the carrier rod itself can comprise at least one joint, so that the carrier rod itself comprises two partial regions which are pivotable with respect to one another. An exact setting and adjustment of the fixing mechanism of a fixing element 111 to 115 can thus be enabled. The adjustment of the effector contour 108 of the effector 110 can be enabled, for example, by integrated actuators (e.g. stepper motors with mechanical transmission to the fixing elements).

The fixing elements 111 to 115 are arranged at the effector 110 in such a way that at least one fixing element 111 to 115 or all at least five guide elements 111 to 115 comprise two degrees of freedom per arm in an x-y plane and in particular a further additional degree of freedom in the z-plane (for folding away inactive fixing elements 111 to 115).

The pentagon as effector contour 108 is defined by the connecting lines between the individual five fixing elements 111 to 115 or the outermost fixing points of the fixing elements 111 to 115, viewed from the effector, at which a holding contact with a held fabric part 140 is present, within the x-y-plane. The connecting lines thus form a pentagonal contour (effector contour) 108 within the fabric part 140. Inside the pentagon 108, the fabric part 140 is spanned (German: gespannt) and thus defines the x-y-plane. At the outer edge regions of the fabric part, which lie outside the pentagon 108, the fabric part can be unspanned (German: ungespannt vorliegen) and in the case of slack or soft fabrics project so to speak from the x-y-plane in the z-direction. In a specific operating state, three fixing elements can be aligned along a straight line.

The effector contour 108, which is formed by the connecting lines of the fixing elements or their fixing points, is smaller than a part of an outer contour of the piece of fabric 140 to be processed. So that the fabric part 140 can be fed to a joining unit (for example sewing machine), it can comprise a protrusion at the edge relative to the effector contour 108.

The fixing force of a fixing element 111 to 115 can be variably controlled. The controllable fixing force can represent a further degree of freedom. Thus, for example, during a certain manipulation, a gripping force or a suction force of the suction device 101 can be precisely so strong that only one fabric part 140 is gripped by the fixing elements 111 to 115 from a stack 141 during the separating.

Furthermore, the fixing force of a fixing element 111 to 115 can change temporally over the holding duration. For example, a high fixing force can be generated by a large amount of suction of a (vacuum) suction device 101 during lifting, but only a small fixing force during displacement of the fabric part 140 onto a worktable, because otherwise, for example, the effector 110 sucks firmly on a worktable.

Actuators 106 are configured to control the handling robot 100 and the functional elements thereof. For example, an actuator 106 can control the arm element 104 of the handling robot 100. The arm element 104 comprises, for example, a plurality of joints, wherein a corresponding actuator 106 for controlling the position of the arm element 104 can be provided at each of the joints. The actuators 106 can be controlled, for example, by a control unit 105.

The robot arm 104 is attached to the robot base 102, for example. An actuator 106 is in particular installed in the robot base 102 and is coupled to at least one of the fixing elements 111 to 115 by means of an adjusting mechanism, for example via cable pulls or hydraulic force transmission elements, such that an actuator force can be transmitted to the effector 110 by means of the adjusting mechanism in order to control the same, so that the actuator 106 is independent of a movement of the effector 110.

The actuator 106 generates, on the one hand, the drive force for one or more fixing elements 111 to 115 and additionally comprises a transmission mechanism or an adjusting mechanism. An actuator 106 can be attached to the effector 110 and move with the effector 110. For example, an actuator 106 can generate or transmit a drive force for a plurality of or even all fixing elements 111 to 115 or an actuator 110 is correspondingly assigned to one fixing element. The actuator 106 can represent, for example, an electric motor or a servo element, which generates a drive force for the fixing elements based on electrical energy. Furthermore, the actuator 106 can represent a hydraulic or pneumatic force generator.

The fixing elements 111 to 115 are configured such that the fabric part 140 remains fixed in position at the joining unit 130 during the entire joining. Due to the mentioned protrusion of the fabric part relative to the effector contour 108 of the effector 110 (for example of 2 cm), it is possible, on the one hand, to ensure sufficient proximity of the guide and thus freedom from folds, but, on the other hand, sufficient distance so that the effector 110 does not collide with the joining unit 130.

The joining unit can, as illustrated in FIG. 1, comprise a sewing machine unit 131, which, for example, approaches a fabric part 140 or sews two fabric parts 140 together.

Furthermore, the handling robot 100 comprises at least different sensor units 103. The sensor units 103 can, for example, comprise optical sensors for determining an orientation of the fabric part relative to the effector 110 and/or the joining unit 130. Furthermore, a sensor 130 can comprise a force sensor for measuring the fixing force of the fixing element 111 to 115 for fixing the fabric part 140 and/or a weight sensor 107 for measuring a weight of the fixed fabric part 140. The handling robot 100 or the control unit 105 is configured to control the fixing elements of the measured sensor parameter of the sensor unit based on the measured sensor parameter of the sensor unit 103.

The effector 110 and the fixing elements 111 to 115 can thus be adapted in real time based on an external sensor signal. For example, an electronic weighing device or weight sensor 107 of the fabric stack 141 or of the load weight on the effector 110 can determine whether actually only one fabric part 140 or one fabric layer has actually been separated. Alternatively, a camera of the sensor unit 103 can monitor the progress of the manipulation in different working steps and at the most act on the fixing mechanism or gripping mechanism or the manipulation of the effector 110.

The control unit 105 is configured to collect and evaluate the data relating to the movement of the effector 110 and data relating to the joining result of the joining unit 130 in order to take measures relating to the control of the movement of the effector 110 and of the joining sequence of the joining unit 120 in the event of a predetermined deviation from a predefinable limit value. The control unit 105 can be coupled to the individual sensors 103 of the system in a wireless or wired manner in order to obtain the corresponding movement data, position data and state data of the effector 110 as well as the data of the joining unit 130 as well as the state data of the joining position or of the joining result of the fabric part 140. Furthermore, the control unit 105 can be equipped with a storage unit with a database or can be coupled to a remote, web-based database or database stored in a cloud. For example, desired values for the data or measured parameters can be present in the database. Based on an actual/desired value comparison, the control unit 105 can generate corresponding control commands for the system.

The control unit 105 is configured accordingly to adapt the gripping or fixing mechanisms in real time based on a sensor signal. For example, an electronic weighing device as a weight sensor 107 of the fabric stack 141 or a sensor for measuring the load weight on the effector 110 can determine whether actually only one fabric layer has actually been separated. Alternatively, a camera as an optical sensor 103 can monitor the progress of the manipulation in different working steps and at the most act back on the gripping mechanism or the manipulation.

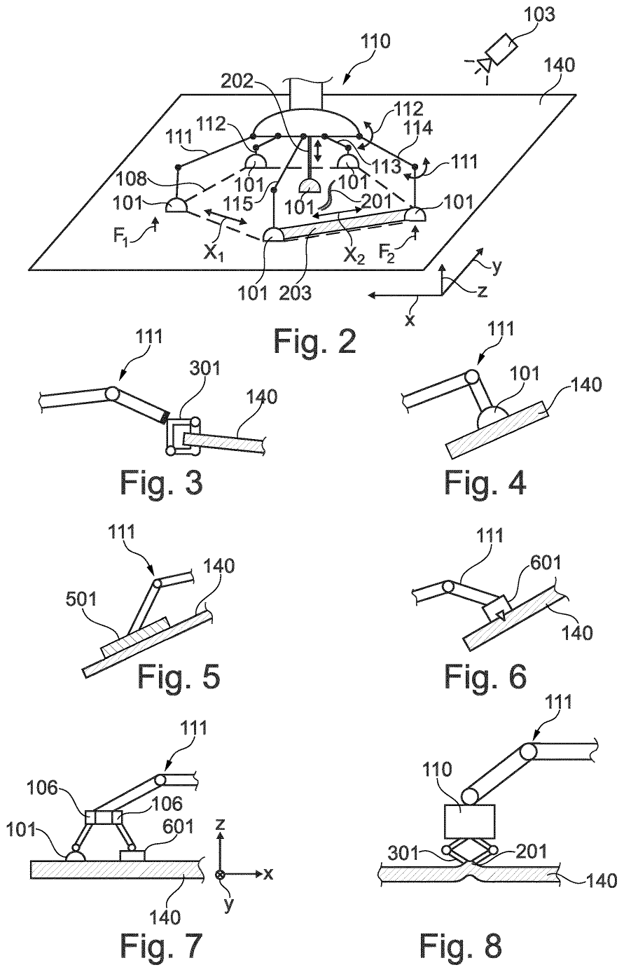

FIG. 2 shows a schematic illustration of the effector 110 with fixing elements 111 to 115. The fixing elements 111 to 115 are configured to grip and fix a piece of fabric 140 to be gripped within the contour of the fabric part 140. Furthermore, the fixing elements 111 to 115 can be positioned relative to one another, so that a fabric part 140 can be spanned. A fold 201 of the fabric part 140 can thus be opened, for example.

In the exemplary embodiment from FIG. 2, the fixing elements 111 to 115 comprise, for example, suction devices 101 as fixing mechanisms, so that the fabric part 140 can be fixed by means of negative pressure. The suction devices 101 are fastened to corresponding carrier rods of the fixing elements 111 to 115. The carrier rods fix the suction devices 101 to the effector 110. The carrier rods can further comprise joints and accordingly adjust the position of the fixing points or the distance to the effector 110. Furthermore, the carrier rods can be formed telescopically retractable and extendable. The carrier rods can further also be arranged pivotably on the effector 110 and thus, for example, adjust the distance between two fixing elements 111 to 115.

The fixing elements 111 to 115 span the pentagon as effector contour 108 between the fixing points with the fabric part 140 or between the suction devices 101. If the distance between two adjacent fixing elements 111 to 115 is increased, the fabric part 140 is accordingly spanned in this region. Particularly in the case of larger fabric parts 140, there is the risk that these sag if they are lifted only at the relevant contour points or fixing points of the fixing elements 111 to 115.

The fixing elements 111 to 115 are thus movable relative to one another in the x-y plane in such a way that end positions of the fixing elements (i.e. the fixing point with the fabric part 140 or at the location of the suction devices 101) are adjustable with two degrees of freedom in the x-y plane. Furthermore, for example, the fixing elements 111 to 115 are in particular movable in the z-direction, so that end positions or fixing points of the fixing elements 111 to 115 are adjustable with three degrees of freedom in the x-y plane and in the z-direction.

Furthermore, a further fixing element 202 is arranged on the effector 110, which is configured to support the fabric part 110 within the spanned effector contour 108 and/or which is configurable to be folded away or retracted in the z-direction, which is oriented perpendicular to the x-y-plane. The further fixing element 202 is also attached to the effector 110 in a pivotable or translationally displaceable manner. The further fixing element 202 also comprises a fixing mechanism at one end, wherein the fixing point of the fixing mechanism with the fabric part 140 forms the effector contour 108 of the pentagon, but is present inside the pentagon. In other words, the further fixing element 202 can push the center of the fabric part away from the effector 110 or pull it toward the latter, in order to avoid sagging of the fabric part 140 in the center of the pentagon.

Furthermore, between two fixing elements 111 to 115 a carrier element 203 can be attached, which carries the fabric part 140 between the fixing elements 111 to 115. The carrier element 202 is, for example, formed elastically in such a way that upon changing the distance of the two fixing elements 111 to 115 a length and a shape of the carrier element 203 is adaptable. The carrier element 203 is configured in particular to hold the fabric part 140 by means of vacuum and/or by means of holding needles. For example, the carrier element 203 can form an elastic and expandable square tube (e.g. made of silicone).

The optical sensor unit can, for example, check the surface of the fabric part 140 and, if necessary, recognize a fold 201 in the fabric part. Based on this, for example, a distance x1 or x2 between adjacent fixing elements 111 to 115 can be set in order to thus eliminate the fold 201. If a distance is increased x2 or decreased, the carrier element 203 can be accordingly lengthened or shortened.

Furthermore, the fixing force F1, F2 and different fixing mechanisms on individual fixing elements 111 to 115 can be individually controlled by means of a control unit 105, so that, for example, a first fixing force F1 of a first suction device 101 differs from a second fixing force F2 of a second suction device 101.

FIG. 3 shows a schematic illustration of a fixing element 111 with a gripper 301. The gripper 301 is formed in such a way that it surrounds the edge of the fabric part 140 and grips the fabric part 140 from above and from below, i.e. from the left and from the right side of the fabric part 140.

FIG. 4 shows a schematic illustration of a fixing element 111 with a suction device 101. The suction device 101 comprises a suction cup, as a result of which a guiding force is generated by means of negative pressure. The suction cup is connected to a vacuum pump or a suction pump in order to suck air out of the suction cup. A negative pressure is generated in the volume between the fabric part 140 and the suction cup, with which negative pressure a fixing force is generated. The negative pressure can be measured, for example, by means of sensor units 103 in order to control the suction power correspondingly by means of the control device 105.

FIG. 5 shows a schematic illustration of a fixing element 111 with an electrostatically charged element 501. An electrostatically charged element can be electrostatically charged, for example, in order thus to correspondingly fix the fabric material of the fabric part 140. The electrostatic charging can be generated, for example, by means of a correspondingly connected current generating device, which is controlled by the control unit 105.

FIG. 6 shows a schematic illustration of a fixing element 111 with holding needles 601. Thus, for example, a fixing mechanism on a fixing element 111 can be configured in such a way that holding needles 601 can be introduced into a stack 141 of fabric parts 140 in such a way that a desired number of superimposed fabric parts 140 can be fixed. Furthermore, by the fixing with different fixing forces F1, F2 of individual fixing elements 111 to 115, a different location-dependent gripping of a certain region of a fabric part 140 can be enabled. Accordingly, the penetration depth and/or a penetration angle of the holding needles 601 can be controlled, in particular in real time and/or based on a sensor feedback.

FIG. 7 shows a schematic illustration of a fixing element 111 with a plurality of different fixing mechanisms, for example with a suction device 101 and holding needles 601 with a suction device 101. In particular, different fixing mechanisms can be applied on one and the same or on different fixing elements 111 to 115. Thus, for example, vacuum nozzles or suction devices 101 can be present for fixing by means of negative pressure and at the same time by means of holding needles 601. The holding needles 301 of the fixing mechanism or the holding needles 601 of the carrier element 203 can comprise a diameter of less than 1300 micrometers, less than 900 micrometers. In the case of fine microneedles as holding needles 6001 in combination with a suitable vacuum negative pressure on the suction devices 101, the fabric part 140 is gripped gently without quality-disturbing effects remaining on the fabric surface.

FIG. 8 shows a schematic illustration of a fixing element 111 with a gripper 301, which grips an upper side of a fabric part 140. The gripper 301 grips a region of a surface of the fabric part 140 in the manner of tongs, so that a fold 201 is formed. The fold 201 is spanned between the tongs-shaped grippers 301, so that the fabric part 140 is fixed.

FIG. 9 shows a schematic illustration of an effector 110 with fixing elements 111, 112, which are formed in the manner of a pantograph with coupling rods 901. An effector base 904 is attached to a robot arm 104 of the handling robot 100. A central rod 902 extends from the effector base 904 in the direction of the fabric part 140. The fixing elements 111, 112 are attached to the central rod 902, wherein the fixing elements 111, 112 comprise a coupling rod mechanism with a plurality of coupling rods 901 connected in an articulated manner at articulation points.

At least two articulation points form fixing points 905, at each of which at least one fixing mechanism, in particular a suction device 101 for fixing the fabric part 140, is provided. The coupling rods 901 are coupled to one another in an articulated manner in the manner of a pantograph in such a way that the fixing points 905 are displaceable relative to the central rod 902 within the x-y plane and maintain a predefined change in distance proportional to the distance from the central rod 902 during the displacement.

If, for example, one fixing point 905 is now moved relative to the central rod 902 by means of an actuator 106, the coupling rods 901 coupled in the manner of a pantograph have the effect that the further fixing point 905 is changed in a predetermined manner proportional to the distance from the central rod 902. The coupling rods 901 form a framework which is designed in the manner of a pantograph in such a way that a predetermined proportionality of the fixing points 905 is given during a displacement.

In order to control the coupling rods 901 and the corresponding distances of the fixing points 905 from the central rod 902, the effector 110 comprises a sliding element 903, which is arranged on the central rod 902 so as to be displaceable along the latter. The coupling rod mechanism is configured in such a way that a first coupling rod 901 is fixedly attached to the central rod 902 and a further second coupling rod 901, which is coupled in an articulated manner to the first coupling rod 901, is attached to the sliding element 903 in such a way that, when the sliding element 903 is displaced along the central rod 902, an angle between the first coupling rod 901 and the second coupling rod 901 and correspondingly the fixing points 905 undergo a predefined change in distance proportional to the distance from the central rod 902.

The sliding element 903 can be guided in a sliding manner along the central rod 902. One end of the first coupling rod 901 is fixedly attached to the central rod 902 and one end of the second coupling rod 901 is fixedly attached to the sliding element 903. If the sliding element 903 now moves in the direction of the coupling point at which the first coupling rod 901 is fixedly attached to the central rod 902, the ends of the first coupling rod 901 and the second coupling rod 901 approach one another. Correspondingly, the angle between the first coupling rod 901 and the second coupling rod 901 becomes smaller and the free ends of the first and second coupling rods 901 correspondingly move away from the central rod 902. A distance of the free ends of the first and second coupling rods 901 from the central rod 902 can thus be set due to the displacement of the sliding element 903 along the central rod 902.

FIG. 10 shows a schematic illustration of an effector 110, on which pivotable fixing elements 111 to 115 are arranged. The fixing elements can for example be attached pivotably to the central rod 902 or pivotably to a corresponding slider 903, which is arranged displaceably on the central rod 902. An additional degree of freedom for the adjustment of the fixing elements 111 to 115 can thus be enabled for the arrangement of the coupling rods 901 in the manner of a pantograph described in FIG. 9. In particular, for example, adjacent fixing elements 111 to 115 can be pivoted relative to one another, so that their distance (in particular in the x-y plane) is adjustable. Furthermore, it is emphasized in the exemplary embodiment that the number of fixing mechanisms, such as for example the suction device 101, varies between the fixing elements 111 to 115. Thus, for example, three suction devices 101 may be arranged on one fixing element 111 and, in the case of another fixing element 112, for example, only two suction devices 101 may be arranged.

In addition, it should be noted that “comprising” does not exclude any other elements or steps and “one” or “one” does not exclude a plurality. Furthermore, it should be noted that features or steps which have been described with reference to one of the above exemplary embodiments can also be used in combination with other features or steps of other exemplary embodiments described above. Reference signs in the claims are not to be construed as a limitation.

List of reference signs:

100 Handling robot
101 Suction device
102 Robot base
103 Sensor unit
104 Arm element
105 Control unit
106 Actuator
107 Weight sensor
108 Pentagon/effector contour
110 Effector
111 First fixing element
112 Second fixing element
113 Third fixing element
114 Fourth fixing element
115 Fifth fixing element
130 Joining unit
131 Sewing machine unit
140 Fabric part
141 Stack
201 Fold
202 Further fixing element
203 Carrier element
301 Gripper
501 Electrostatically charged element
601 Holding needle
901 Coupling rod
902 Central rod
903 Sliding element
904 Effector base
905 Fixing point
x1 Distance between fixing elements
x2 Distance between fixing elements
F1 First fixing force
F2 Second fixing force

1-27. (canceled)

28. A system for handling and processing fabric parts, the system comprising:
a handling robot with an effector for handling a fabric part;
a joining unit for at least one of processing a fabric part and connecting at least two fabric parts;
wherein the effector is configured to feed a fabric part to the joining unit and to hold it during processing by the joining unit;
wherein the effector comprises at least five fixing elements;
wherein each fixing element is configured to fix a region of the fabric part to the effector; and
wherein the five fixing elements are coupled to the effector so as to be movable relative to one another along an x-y plane in such a way that an adjustable pentagon can be formed within the x-y plane by connecting lines between the fixing elements, thereby allowing that a fixable fabric part can be spanned.

29. The system according to claim 28,
wherein the fixing elements are configured to grip a piece of fabric to be gripped at least one of after and during fixing to the fixing elements also within the contour of the piece of fabric or to re-span the piece of fabric by moving the fixing elements relative to one another.

30. The system according to claim 28,
wherein the effector comprises at least one further fixing element, which is at least one of configured to support the piece of fabric within the spanned contour and configurable to be folded away in the z-direction, which is oriented perpendicular to the x-y-plane.

31. The system according to claim 28, comprising at least one of the following features:
wherein the effector comprises at least six, eight or ten fixing elements, which are coupled to the effector so as to be movable relative to one another along the x-y plane in such a way that connecting lines between the fixing elements form at least one adjustable hexagon, octagon or decagon within the x-y plane, thereby allowing that the fixable fabric part can be spanned;
wherein a contour, which is formed by the connecting lines of the fixing elements, is adjustable to be smaller than a part of an outer contour of the piece of fabric to be processed, at least during a part of the processing of the fabric part.

32. The system according to claim 28,
wherein at least one of the fixing elements comprises a fixing mechanism selected from the group consisting of grippers, suckers, clamps, regions with at least one of increased friction and electrostatic attraction, needles, rollers, freezing grippers, and Bernoulli grippers.

33. The system according to claim 32, comprising at least one of the following features:
wherein at least one of the fixing elements is configured to fix the piece of fabric either from a right side of the piece of fabric or from a left side of the piece of fabric, and
wherein at least one of the fixing elements is configured to fix the piece of fabric from a right side of the piece of fabric and from a left side of the piece of fabric.

34. The system according to claim 33, comprising at least one of the following features:
wherein the fixing force of one of the fixing elements is adjustable depending on a fixing location within the contour of the fabric part;
wherein the fixing mechanism of one of the fixing elements is adjustable depending on a fixing location of the fabric part;
wherein at least one of the fixing force and the fixing mechanism of one of the fixing elements is adjustable depending on a temporal processing state of the fabric part.

35. The system according to claim 28, comprising at least one of the following features:
wherein at least one of the fixing elements comprises an actuator, which is configured to at least one of
control the fixing of the fabric part,
control the displacement of the fixing element within the x-y-plane;
wherein the effector comprises an actuator, which is configured to transmit a fixing force to the fixing element for at least one of fixing the fabric part and to control a displacement force to the fixing element for displacing the fixing element within the x-y-plane.

36. The system according to claim 28, comprising at least one of the following features:
wherein the effector comprises more than 10 fixing elements;
wherein at least one of the fixing elements can be fixed in one position with a position holding force,
wherein the position holding force is less than ⅕ of the power, which can be used for displacing the corresponding fixing element.

37. The system according to claim 35,
wherein the handling robot comprises a robot base, on which the effector is movably arranged; and
wherein the actuator is coupled to at least one of the fixing elements by means of an adjusting mechanism such that an actuator force can be transmitted to the effector by means of the adjusting mechanism in order to control the same, so that the actuator is independent of a movement of the effector.

38. The system according to claim 28, comprising at least one of the following features:
wherein the fixing elements are configured such that the piece of fabric is fixed to the joining unit or to the joining units during the entire joining;
wherein the joining unit is selected from the group consisting of sewing machines, welding machines for welding fabric parts, stitching machines for stitching fabric parts, crocheting machines, automatic gluing machines for gluing fabric parts, and automatic ironing machines for ironing a fabric part;
wherein the handling robot comprises at least one of:
at least one sensor unit; and
wherein the sensor unit comprises an optical sensor for determining an orientation of the fabric part relative to at least one of the effector and the joining unit,
a force sensor for measuring the fixing force of the fixing element for fixing the fabric part and
a weight sensor for measuring a weight of the fixed fabric part,
wherein the handling robot is configured to control the fixing elements based on the measured sensor parameters of the sensor unit;
wherein the fixing elements are movable relative to one another in an x-y plane in such a way that end positions of the fixing elements are adjustable with two degrees of freedom in the x-y plane.

39. The system according to claim 32,
wherein the fixing mechanism comprises holding needles, which is configured in such a way that at least one of a penetration depth and a penetration angle of at least one holding needle is controllable.

40. The system according to claim 28,
wherein at least between two fixing elements a carrier element is attached, which carries the fabric part between the fixing elements,
wherein the carrier element is formed elastically in such a way that upon changing the distance of the two fixing elements a length and a shape of the carrier element is adaptable.

41. The system according to claim 32,
wherein holding needles of the fixing mechanism or the holding needles of the carrier element have a diameter of less than 1300 micrometers.

42. The system according to claim 28,
wherein the effector comprises an effector base and a central rod;
wherein the effector base is attached to an arm element of the handling robot and the central rod extends from the effector base;
wherein the fixing elements are attached to the central rod;
wherein at least one fixing element comprises a coupling rod mechanism with a plurality of coupling rods connected in an articulated manner at articulation points;
wherein at least two articulation points form fixing points, at each of which at least one fixing mechanism is provided for fixing the fabric part; and
wherein the coupling rods are coupled to one another in an articulated manner in the manner of a pantograph in such a way that the fixing points are displaceable relative to the central rod within the x-y plane and maintain a predefined change in distance proportional to the distance from the central rod during the displacement.

43. The system according to claim 42, comprising at least one of the following features:
wherein the fixing elements are attached pivotably to the central rod;
wherein the effector comprises a sliding element, which is arranged on the central rod so as to be displaceable along the latter; and
wherein the coupling rod mechanism is configured in such a way that a first coupling rod is fixedly attached to the central rod and a further second coupling rod, which is coupled in an articulated manner to the first coupling rod, is attached to the sliding element in such a way that, when the sliding element is displaced along the central rod, an angle between the first coupling rod and the second coupling rod and correspondingly the fixing points undergo a predefined change in distance proportional to the distance from the central rod.

44. The system according to claim 28, further comprising
a control unit for controlling at least one of the handling robot and the joining unit,
wherein the control unit is configured to collect and evaluate the data relating to the movement of the effector and data relating to the joining result of the joining unit in order to take measures relating to the control of the movement of the effector and of the joining sequence of the joining unit in the event of a predetermined deviation from a predefinable limit value.

45. The system according to claim 32,
wherein in the case of a fixing mechanism by means of suction devices for fixing the fabric part, the negative pressure in the fixing mechanism can be varied by more than 15%.

46. A method for handling and processing fabric parts, the method comprising:
separating a fabric part from a fabric stack by means of an effector of a handling robot for handling the fabric part;
feeding the fabric part to a joining unit by means of the effector;
at least one of processing the fabric part in a joining unit and connecting at least two fabric parts by the joining unit,
wherein the effector is configured to hold the fabric part during processing by the joining unit,
wherein the effector comprises at least five fixing elements,
wherein each fixing element is configured to fix a region of the fabric part to the effector; and
moving the fixing elements relative to one another along an x-y plane relative to one another, so that connecting lines between the fixing elements form an adjustable pentagon within the x-y plane, thereby allowing that the fixed fabric part can be spanned.

47. The method according to claim 46,
wherein two fabric parts are at least partially superimposed and fixed at the joining unit by means of the effector.
